(19) United States
(12) Patent Application Publication
(10) Pub. No.: US 2009/0226351 A1
(43) Pub. Date: Sep. 10, 2009

(54) Supercritical Oxidation Process for the Treatment of Corrosive Materials

(76) Inventor: Ariel Rosenberg, Bnei Zion (IL)

Correspondence Address: NIXON & VANDERHYE, PC, 901 NORTH GLEBE ROAD, 11TH FLOOR, ARLINGTON, VA, 22203, US

(21) Appl. No.: 12/223,647

(22) PCT Filed: Feb. 6, 2007
(86) PCT No.: PCT/IL2007/000150

§ 371 Date: May 2, 2009

(30) Foreign Application Priority Data
Feb. 6, 2006 (IL) 173547

(51) Int. Cl. C01B 17/90; B01D 11/00; C22B 3/00

(52) U.S. Cl. 423/1; 210/761; 423/531

(57) ABSTRACT

A supercritical oxidation process, which comprises pressurizing and heating an aqueous system to form a fluid phase under supercritical conditions, feeding an oxidizer into said fluid phase to cause an oxidation reaction therein, directing the resultant fluid reaction phase into a central region of a cooling chamber while providing a coolant in an internal peripheral region of said cooling chamber, said peripheral region being adjacent to the inner surface of the cooling chamber, mixing the fluid reaction phase with said coolant within the cooling chamber, removing the reaction mixture from said cooling chamber and subsequently further reducing the temperature and the pressure of said reaction mixture to obtain a product mixture.

It has been proposed in the art to perform oxidation reactions of corrosive materials such as sulfides-containing aqueous media under supercritical conditions, namely, at temperature above 374° C. and pressure above 22.1 MPa. Under these conditions, the reaction mixture is in the form a single, fluid phase. The art has also recognized the potential of the aforementioned technology for treating contaminated water in order to destroy organic impurities present therein.

Upon completion of the oxidation reaction, it is necessary of course to cool the fluid reaction phase and to reduce its pressure. However, when the water to be treated initially contains precursors of potentially corrosive substances, such as sulfide compounds, the transition from the supercritical conditions into a domain of lower temperature and pressure inevitably results in the formation of highly corrosive chemical species, e.g., sulfuric acid, which is expected to attack and damage the reaction vessel or accompanying piping further downstream. Hereinafter, the term “sub-critical phase” refers to the water phase below the critical point, wherein, however, the temperature of said water phase is still considerably high, namely, above 150° C. The enhanced corrosion capacity of this sub-critical phase presents a major obstacle for the application of supercritical water oxidation processes.

In its broadest embodiment, the present invention provides an improved supercritical oxidation process, which comprises pressurizing and heating an aqueous system to form a fluid phase under supercritical conditions, feeding an oxidizer into said fluid phase to cause an oxidation reaction therein, directing the resultant fluid reaction phase into a central region of a cooling chamber while providing a coolant in an internal peripheral region of said cooling chamber, said peripheral region being adjacent to the inner surface of the cooling chamber, mixing the fluid reaction phase with said coolant within the cooling chamber, removing the reaction mixture from said cooling chamber and subsequently further reducing the temperature and the pressure of said reaction mixture to obtain a product mixture. Thus, according to the present invention, the transition from supercritical conditions to a sub-critical phase is accomplished in a cooling chamber by rapidly lowering the temperature of the fluid reaction mixture passing therethrough to the range of 300° C. to 100° C., and preferably below 150° C., followed by further cooling, heat recovery and pressure reduction. As will be discussed in detail below, according to preferred arrangements of the present invention, the interior of the cooling chamber comprises a central flow region and a peripheral region surrounding the same, such that the flow of the reaction mixture is carried out through said central region, whereby an immediate direct contact of the hot feed with the inner surface of the cooling chamber is prevented or at least delayed. Furthermore, by appropriately controlling the introduction of the coolant into the cooling chamber, it is possible to form a protective coolant layer onto the inner walls thereof.

The aqueous system to be treated according to the present invention may be either in the form of a solution or a suspension. According to a particularly preferred embodiment, the aqueous system comprises sulfides represented by the formula MₓS_{y}, wherein M is a metal cation and x and y are the stoichiometric coefficients of the metal and sulfur, respectively. The process according to the present invention is especially useful for recovering metal sulfides from mineral ores, concentrates, and residues accompanying the mineral industry as well as from catalysts, such as molybdenum sulfide, which is used in the petroleum industry.

It should be noted that the improved supercritical oxidation process provided by the present invention may be applied for various purposes. For example, water contaminated by organic or inorganic impurities and by precursors of corrosive substances may be effectively purified by the process of the present invention. In another embodiment, the process may be used for producing concentrated solutions of sulfuric acid. In yet another embodiment, the process may be used to form enriched solutions of valuable elements and minerals, which may be subsequently easily recovered therefrom.

The aqueous system to be treated according to the present invention is brought into the supercritical conditions, wherein the temperature and pressure are preferably above 400° C. and 25 MPa, respectively, by using gravitation or a pump or a series of high pressure pumps. The temperature of the aqueous system is raised by passing the same through one or more heat exchangers, and also by contacting said aqueous system with hot medium or directly with electrical heaters.

The reaction vessel, in which the oxidation under supercritical conditions is carried out, is preferably a tubular, plug flow reactor, or a similar device allowing the required residence time, in accordance with the flow parameters of the aqueous system, the reactor's volume, and the amount and flow characteristics of the oxidizing agent.

Suitable oxidizers to be used according to the present invention most preferably include oxygen, air and hydrogen peroxide, which may be fed into the aforementioned tubular, plug flow reactor either from a high pressure source or by inline pumps or compressors, either in a stoichiometric amount, and more preferably in a slight excess. The oxidation reaction performed under supercritical conditions is allowed to reach completion, namely, organic matter present therein is oxidized into carbon dioxide and water, and sulfide present therein is oxidized. During the oxidation reaction, heat is being generated and is preferably recovered.

Upon completion of the oxidation reaction, the reaction mixture is transferred to a cooling chamber, which is designed to allow a rapid reduction of the temperature of the reaction mixture passing therethrough to below 300° C., and preferably below 150° C. An important feature of the present invention is that upon entering the cooling chamber, the reaction mixture is forced to flow through the central region thereof, such that the contact between the reaction mixture and the walls of the cooling chamber is prevented, or at least delayed. For example, according to one embodiment of the invention, the reaction mixture is fed into the cooling chamber by means of a suitable nozzle that is centrically positioned within the inlet of said cooling chamber, which nozzle injects the reaction mixture into the interior of the cooling chamber whose volume is occupied by the coolant.

Preferably, the process according to the present invention comprises passing the fluid reaction phase resulting from the oxidation reaction through a central region which is co-axially and concentrically provided within the cooling chamber while tangentially introducing one or more coolant streams into an annular peripheral region defined between said central region and the inner surface of said cooling chamber. FIGS. 1 and 2 illustrate suitable arrangements for carrying out this embodiment of the invention.

With reference to FIG. 1, the walls of the cooling chamber 1 are made of a corrosion-resistant metal, which is preferably selected from the group consisting of tantalum, titanium, hastalloy, inconell and high temperature stainless steels. The inner surfaces of the cooling chamber may alternatively be coated by composite materials or suitable plastics. The reaction mixture exiting the pressurized reaction vessel (not shown) is caused to flow through a feed line 2 leading into the interior of the cooling chamber 3, such that a portion of said feed line enters into the cooling chamber, said portion being co-axially and preferably concentrically placed within the interior of said cooling chamber. The length of the cooling chamber may vary in the range between tens of centimeters and tens of meters, and the portion of the feed line that enters the interior of the cooling chamber may occupy about 5 to 95% of said length. Numerals 1in and 1out indicate the inlet and the outlet of the cooling chamber, respectively, and the arrows are accordingly used to indicate the flow direction. It may be understood that the cooling chamber may be positioned either horizontally, as shown in the figure, or vertically, or in an inclined manner.

As shown in FIG. 1, the interior space of the cooling chamber is generally cylindrical, but it may also have a frustum shape, namely, sections thereof may have a conical character (as shown by numeral 5), generating a gradual reduction in the diameter of the interior space of the cooling chamber.

In the end of the feed line tube an opening 6 is provided, the diameter of which is typically between 5-100% of the tube diameter. The nozzle opening 6 may be configured to assist flow direction and distribution along and around the chamber.

The coolant streams 7 are preferably tangential relative to the cooling chamber, in order to force the flow of said coolant streams to circulate thereon and protect the surface area thereof. The angle may vary from full tangential to full radial and a lengthwise angle from minus 45 deg to plus 45 degrees.

According to the embodiment shown in FIG. 1, the fluid reaction phase is forced out of the central region through opening 6 downstream within the cooling chamber, whereby it becomes mixed with the coolant.

Alternatively, the flow of the fluid reaction phase through the cooling chamber is confined within the central region thereof, and the mixing of the fluid reaction phase and coolant streams is carried out within said central region. This embodiment of the invention may be carried out using the arrangement shown in FIG. 2, where the tube 2 extends along the entire length of the cooling chamber, defining a central flow region therein, said tube comprises a plurality of nozzles 8 along its surface. The annular space 9 formed between the tube 2 and the inner surface 10 of the external wall of the cooling chamber holds the pressurized coolant, which is forced into tube 2 through said plurality of nozzles 8 in various angles, to allow rotational as well as longitudinal flow of both the process feed and the cooling fluid within tube 2. The coolant streams may be fed either tangentially or radially or in any combination of the two into the annular space. For example, it is possible to inject a plurality of streams of coolant fluids from ring shaped injection means that are positioned along the cooling chamber, thereby also providing a chilled boundary layer onto its inner walls.

The coolant fluid may be water, or an alkaline aqueous solution (e.g. a solution of sodium hydroxide), or a cooled product effluent of the reaction itself or a liquid gas. For example, when the process is also intended for the production of concentrated solutions of sulfuric acid or recovery of valuable materials, it is possible to recycle the cooled sulfuric acid solution obtained by the process and to use the same as the injected coolant media until the concentration of the solution reaches a desired level, which is maintained by removing a portion thereof for further treatment. In another embodiment flushing and evaporation may also be used for prompt cooling.

Hence, the temperature of the aqueous reaction mixture exiting the cooling chamber is sufficiently low, such that the corrosion capacity of chemical species present therein is significantly diminished to allow the subsequent temperature and pressure reduction to be performed at conventional devices made of stainless steel, plastics or composite materials. This may be achieved by various types of construction well known in the art such as valves, expansion vessels, turbines (which can assist in recovering some of the energy), lengthy tubes, pressure breakers, pressurized pumps or by the virtue of gravitation.

Having obtained the final, treated water system, valuable metals (e.g., in the form of their oxides/hydroxides) may be recovered therefrom whereas the solution (containing sulfuric acid) may be recycled and used as the coolant stream to be injected into the cooling chamber in accordance with the process of the invention.

An apparatus suitable for carrying out the process according to the present invention is illustrated in FIG. 1. The apparatus is specifically adapted for the oxidation of metal sulfides such as molybdenum sulfide or copper sulfide, and hence the recovery of valuable metals such as molybdenum or rhenium.

The material molybdenum sulfide is transferred from its storage tank 21 into a physical size reduction device 22 equipped with milling balls, following which it is classified and sized (23, 24) to recover a desired fraction which is transferred into a storage tank 25. The aqueous system is pumped by 26 and 27 to a pressure of about 250 Atmospheres and is heated by the heat exchanger 28 and further heated by an electrical heater 29 to 400° C. to form a super critical water phase, which then enters the reactors 30 and 31, into which the oxidizing agent, oxygen from 32 is supplied. In the plug flow tubular reactors 30 and 31 the oxidation reaction is started and completed. The super critical reaction phase is then passed through a fast cooling chamber 33, whose various configurations thereof were discussed in detail above, where it is cooled to about less than 200-250° C. by means of the recycled liquid 34, and is then further cooled by heat exchangers 28 and 35, flushing vessel 36, following which it enters the product vessel 37. The cooling liquid from the solution at the product vessel is recycled by pumping the same using 38 to the cooling chamber 33. The metal oxides and the sulfuric acid obtained are pumped by 39 for further processing in 40.

### IN THE DRAWINGS

FIG. 1 illustrates a preferred embodiment of the cooling chamber.

FIG. 2 illustrates another preferred embodiment of the cooling chamber.

FIG. 3 schematically shows an apparatus for carrying out the super critical oxidation process of the invention.

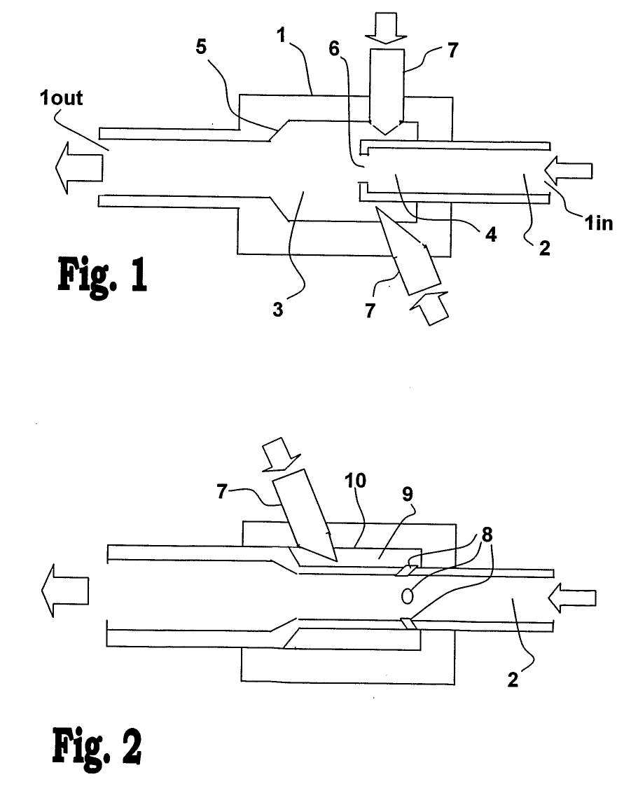

### EXAMPLES

### Example 1

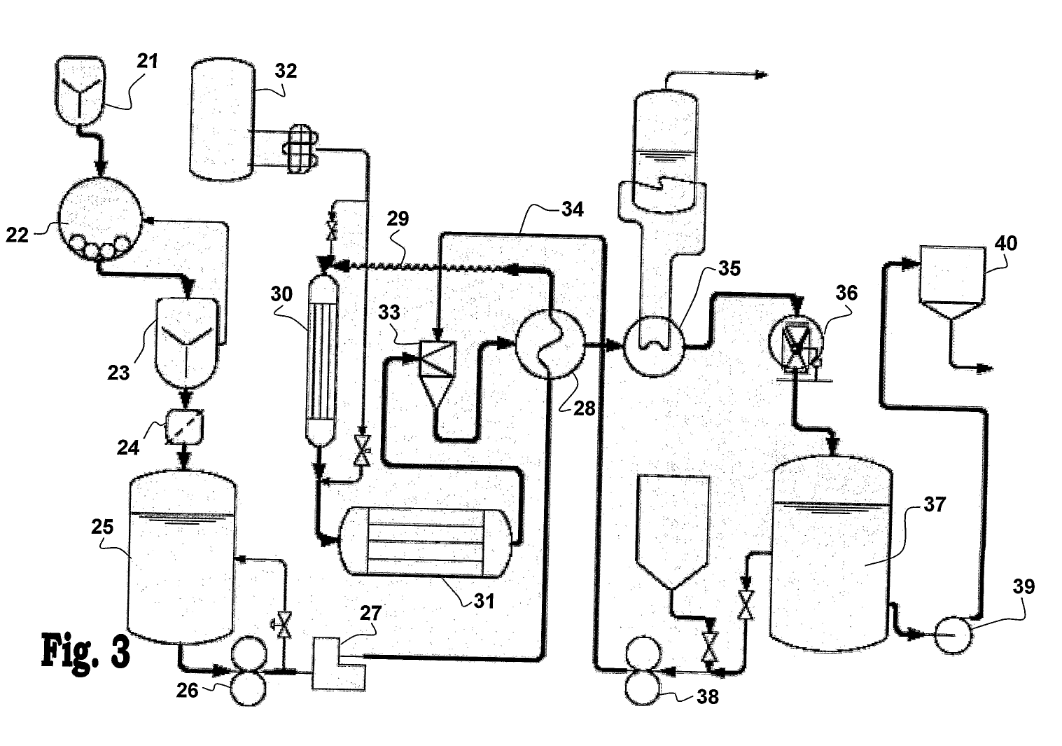

With reference to FIG. 3, molybdenum sulfide concentrate is mixed with water, ratio solid:liquid=1:4 and is forwarded to the feed tank 25 as a slurry. From this collector, the slurry is pumped with the pumps 26, 27 through the heaters to the reactors 30 and 31 with T=390° C. The oxidizing agent is supplied to the reactors in 22-25 MPa pressure.

Under these conditions, the oxidation of molybdenum sulfide takes place:

MoS₂+3H₂O+4.5O₂═H₂MoO₄+2H₂SO₄

The resulting slurry is transferred to the cooling chamber 33 having the configuration described above, to which a cooling solution (10° C.-25° C.) is injected. Circulation of this solution with ratio 2:1 to the raw solution provided a rapid reduction of the slurry temperature to about 200° C.

When the concentration of the recycled sulfuric acid solution exceeds a pre-determined limit, it is removed from the process for further molybdenum recovery.

### Example 2

The same experiment was performed with mixed copper sulfide (chalcopyrite). The ratio solid:liquid is 1:5, T=400° C., P=20-25 MPa. As in the Example 1, the quenching of the reaction was accomplished using a recycled solution (10° C.-25° C.) as the coolant, with the ratio to the raw solution being 2:1. By means of this, the desired temperature of the slurry, T<=200° C. was reached in the cooling chamber. The final solution contained 80 g/l Cu; 20 g/l H₂SO₄; 5 g/l Fe.

The performed experiments show that quenching with cooled recycled solutions (T=10° C.-25° C.) decreases the temperature to below 200° C. while preventing corrosion in the cooling chamber and the connected hardware.

1) A supercritical oxidation process, which comprises pressurizing and heating an aqueous system to form a fluid phase under supercritical conditions, feeding an oxidizer into said fluid phase to cause an oxidation reaction therein, directing the resultant fluid reaction phase into a central region of a cooling chamber while providing a coolant in an internal peripheral region of said cooling chamber, said peripheral region being adjacent to the inner surface of the cooling chamber, mixing the fluid reaction phase with said coolant within the cooling chamber, removing the reaction mixture from said cooling chamber and subsequently further reducing the temperature and the pressure of said reaction mixture to obtain a product mixture.

2) A process according to claim 1, which comprises passing the fluid reaction phase through a central region which is co-axially and concentrically provided within the cooling chamber while tangentially introducing one or more coolant streams into an annular peripheral region defined between said central region and the inner surface of said cooling chamber.

3) A process according to claim 2, wherein the fluid reaction phase is forced out of the central flow region downstream within the cooling chamber, whereby it becomes mixed with the coolant.

4) A process according to claim 2, wherein the flow of the fluid reaction phase through the cooling chamber is confined within the central region thereof, and the mixing of the fluid reaction phase and coolant streams is carried out within said central region.

5) A process according to claim 1, wherein the aqueous system comprises one or more metal sulfides.

6) A process according to claim 5, wherein the product mixture is treated to recover metals therefrom and its liquid phase, which comprises a solution of sulfuric acid, is recycled and used as the coolant stream.

7) A process according to claim 1, wherein the reaction product is recycled to form a concentrated sulfuric acid.

8) A process according to claim 1, wherein the reaction product is recycled to form an enriched solution of recoverable elements and compounds.
